(19) United States
(12) Patent Application Publication
(10) Pub. No.: US 2004/0247415 A1
(43) Pub. Date: Dec. 9, 2004

(54) Slotted fastener and fastening method

(76) Inventor: Peter G. Mangone JR., Golden, CO (US)

Correspondence Address: GARDNER CARTON & DOUGLAS LLP, ATTN: PATENT DOCKET DEPT., 191 N. WACKER DRIVE, SUITE 3700, CHICAGO, IL, 60606, US

(21) Appl. No.: 10/454,016

(22) Filed: Jun. 4, 2003

(51) Int. Cl. F16B 15/00

(52) U.S. Cl. 411/457

(57) ABSTRACT

The present invention provides a slotted fastener for attachment to a mounting surface that includes a generally U-shaped wire member having a crown portion, a first leg and a second leg, the first leg and second legs connected to the crown portion by first and second shoulders, respectively, the first and second shoulders having first and second generally concave slots, respectively, the generally concave slots generally distal to the mounting surface. The slotted fastener is shaped to mate with a ram, the ram used to attach the fastener to the mounting surface. Also provided is a method for fastening said slotted fastener to the mounting surface by means of a delivery tool.

### FIELD OF THE INVENTION

The present invention generally relates to surface penetrating fasteners, more specifically to a method to controllably affix generally cylindrical articles to planar surfaces with the assistance of slotted fasteners and an impact delivery mechanism and a ram.

### BACKGROUND OF THE INVENTION

A common method for installing cabling, tubing, or other tubular or cylindrical objects is to fasten said cylindrical objects to a mounting surface such as a wall, a floor, or other similar surfaces. Previous methods of fastening cylindrical articles, such as tubing or cabling, to a surface have made use of individual, manually applied clips or conventional staple guns. Attachment of cylindrical articles by using a conventional staple gun is faster and more economical than use of manually applied clips, but it has been found that stapling may have a harmful effect on the cylindrical article.

Electric, manual, and pneumatic tools are generally known for driving fastening devices which affix cabling, tubing, or other tubular or cylindrical objects to a surface. In building construction, for example, electrical wiring used to transmit electricity and tubing is used in radiant heating systems, water delivery systems, gas supply systems, air conditioning, etc. As a part of installing such systems, the wiring and/or tubing is conventionally mounted against planar surfaces. For example, when installing certain types of in-floor heating systems, an arrangement of tubing is affixed to the underside of flooring or on top of the flooring base then covered with concrete. In other applications, wiring or tubing is frequently mounted to other types of planar surfaces, such as wooden joists, studs, or walls. One of the methods of mounting wiring or tubing to a surface entails the use of fasteners. Such fasteners are provided in various configurations, one of which generally includes a U-shaped body having a cutout dimensioned to receive a wiring or tubing cross-section. The U-shaped body generally straddles the wiring or tubing and has shoulders that are fashioned to abut the mounting surface on opposite sides of the wiring or tubing and limit the depth to which the fastener may be driven. Accordingly, the need exists for a power-assisted fastener delivery system that can deliver multiple driving forces until, and only until, the fasteners are driven into the surface to a desired depth.

Thus, there is a need for a fastener that can affix a generally cylindrical article such as wiring or tubing to a surface in a quick and efficient manner without damaging said article. There is also a need for a fastening method using an impact delivery tool that conveniently, efficiently, and safely attaches a generally cylindrical article such as wiring or tubing to mounting surface in a quick and efficient manner without damaging said article.

### BRIEF SUMMARY OF THE INVENTION

The present invention provides a generally U-shaped wire fastener for attachment to a mounting surface, having a crown portion, a first leg and a second leg, the first leg connected to the crown portion by a first shoulder that is generally parallel to the mounting surface, and the second leg connected to the crown portion by a second shoulder that is generally parallel to the mounting surface; the first shoulder having a first generally concave slot generally distal to the mounting surface, and the second shoulder having a second generally concave slot generally distal to the mounting surface.

In one embodiment of the present invention, the fastener has a first generally concave slot and a second generally concave slot that are shaped to generally mate with a ram, the ram used to attach the fastener to the mounting surface.

Also provided is a method for fastening a slotted fastener to a mounting surface by means of a delivery tool having a base member, a driving member mounted to the base member, the driving member pivotably attached to the base member and movable in an arcuate path relative to the base member, an impact delivery mechanism mounted to the driving member, the impact delivery mechanism including a force delivery member which is movable in a reciprocating manner relative to the driving member, and a ram slidably mounted to the base member, the ram adapted to move generally along a guided direction perpendicular to the mounting surface, the ram positioned to receive at least one impact force from the force delivery member, the method comprising: aligning the slotted fastener within the delivery tool; delivering impact forces to the ram toward the slotted fastener in a direction generally perpendicular to the mounting surface; and pushing the slotted fastener with the ram such that at least a portion of the slotted fastener penetrates the mounting surface. In this embodiment the ram is shaped to generally mate with the slotted fastener.

### BRIEF DESCRIPTION OF THE DRAWINGS

FIG. 1 illustrates a front elevation view of one embodiment of a slotted fastener of the present invention.

FIG. 1A illustrates a partial side view of several embodiments of a concave slot geometric configuration in a shoulder of the slotted fastener of the present invention.

FIG. 1B illustrates a sectional view of several embodiments of a concave slot geometric configuration in a wire member of the slotted fastener of the present invention along line 1c-1c of FIG. 1C, or alternatively along line 1d-1d of FIG. 1D.

FIG. 1C illustrates a front elevation view of an alternative embodiment of the slotted fastener of the present invention.

FIG. 1D illustrates a front elevation view of another alternative embodiment of the slotted fastener of the present invention.

FIG. 2 illustrates a left side elevation view of the slotted fastener of FIG. 1.

FIG. 2A illustrates a left side elevation view of an alternative embodiment of a slotted fastener of the present invention.

FIG. 3 illustrates a bottom view of the slotted fastener of FIG. 1.

FIG. 4 depicts a perspective view of a slotted fastener stack in a preferred embodiment of the present invention.

FIG. 5 illustrates a front elevation view of one embodiment of a ram of the present invention used in the delivery tool useful in using the embodiments of the present invention, adapted to mate with the slotted fastener of FIG. 1.

FIG. 6 illustrates a side elevation view of the ram of FIG. 5.

FIG. 6A illustrates a side elevation view of an alternative embodiment of a ram of the present invention used in the delivery tool useful in using the embodiments of the present invention, adapted to mate with the slotted fastener of FIG. 2A.

FIG. 6B illustrates a side view of an alternative embodiment of a blade end of the ram of FIG. 6.

FIG. 7 illustrates a bottom view of the ram of FIG. 5.

FIG. 8 illustrates an end view of one embodiment of a magazine used to hold a plurality of the fastener of FIG. 1.

FIG. 9A illustrates a front elevation view of one embodiment of a nail of the present invention.

FIG. 9B illustrates a side elevation view of the nail of FIG. 9A.

FIG. 10 illustrates a front elevation view of an alternative embodiment of a ram of the present invention used in the delivery tool useful in using the embodiments of the present invention, adapted to mate with the slotted fastener of FIG. 9A.

FIG. 11 illustrates a side elevation view of the ram of FIG. 10.

FIG. 12 illustrates a bottom view of the ram of FIG. 10.

FIG. 13 illustrates an end view of an alternative embodiment of a magazine used to hold a plurality of the nail of FIG. 9A.

### DETAILED DESCRIPTION OF THE INVENTION

Delivery tools have been developed to fasten U-shaped fasteners onto a mounting surface. The delivery tool can include a driving member, an impact mechanism mounted to the driving member, the mechanism including a movable force delivery member, and a ram slidably mounted in the delivery tool and positioned to receive at least one impact force from the force delivery member. The delivery tool can include a magazine of fasteners. A delivery tool of this type is disclosed in U.S. Pat. No. 6,481,612 to Mangone, which is herein incorporated by reference.

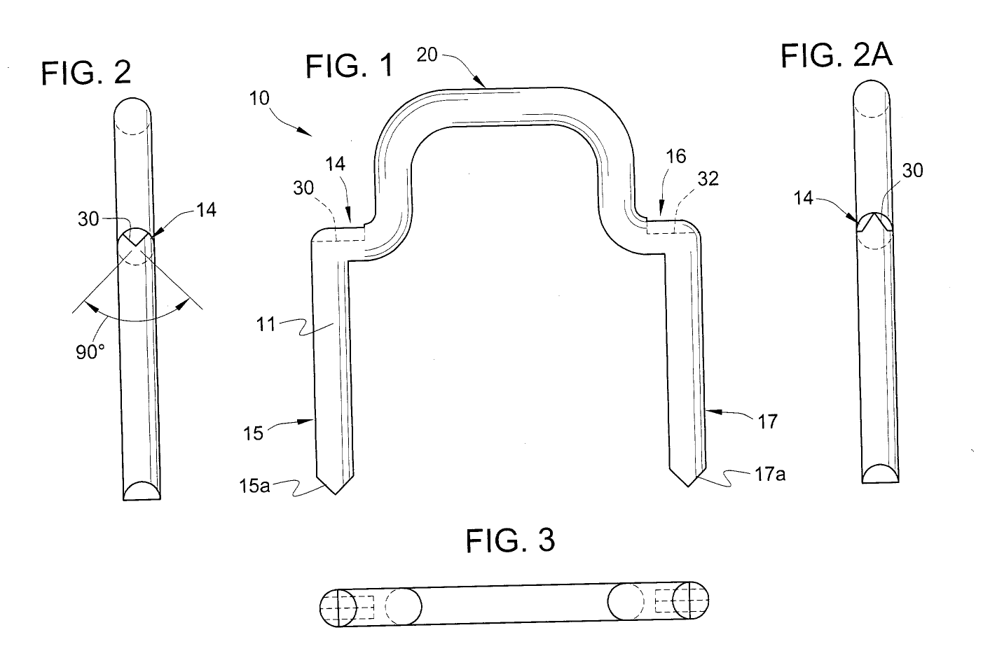

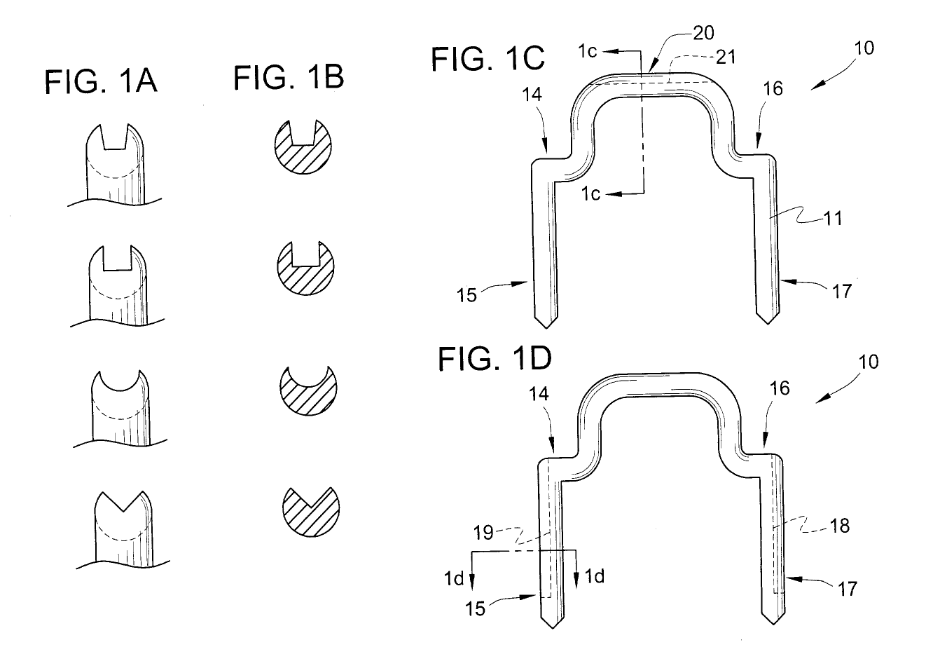

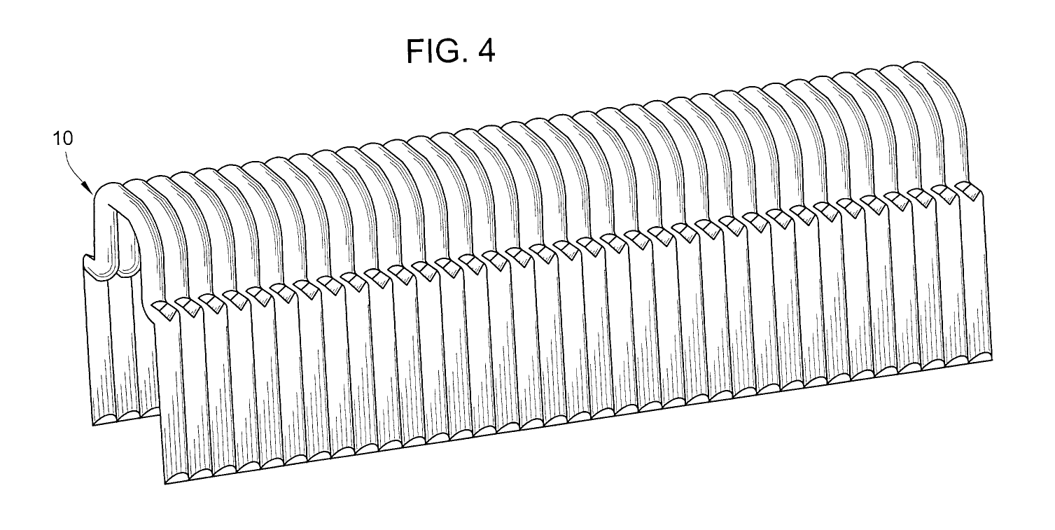

As shown in FIGS. 1-3, in one embodiment of the present invention there is disclosed a fastener 10 for attachment to a mounting surface (not shown). The fastener 10 includes a generally U-shaped wire member 11 having a crown portion 20, a first leg 15, and a second leg 17. The first leg 15 is connected to the crown portion 20 by a first shoulder 14 fashioned to be generally parallel to the mounting surface to which the fastener is to be attached, and the second leg 17 is connected to the crown portion 20 by a second shoulder 16 fashioned to be generally parallel to the mounting surface to which the fastener is to be attached. The fastener 10 is shaped so that at least one concave slot is positioned at and extends along at least one portion of the generally U-shaped wire member 11 in a direction generally distal to the mounting surface. For example, in this embodiment, the first shoulder 14 has a first generally concave slot 30 and the second shoulder 16 has a second generally concave slot 32. Both the first generally concave slot 30 and the second generally concave slot 32 generally are distal to the mounting surface. For example, the first generally concave slot 30 can extend along the first shoulder 14, and the second generally concave slot 32 can extend along the second shoulder 16. The first generally concave slot 30 can extend along the entire length or along a portion of the length of the first shoulder 14, and the second generally concave slot 32 can extend along the entire length or along a portion of the length of the second shoulder 16. The first generally concave slot 30 and the second generally concave slot 32 can have any shape adapted to receive and mate with a ram 50, that is described in further detail below. For example, the first generally concave slot 30 and the second generally concave slot 32 can have various geometric shapes, including V-shaped, U-shaped, or other geometric shapes such as rectangular or trapezoidal having one open side, as shown in FIG. 1A. The first leg 15 terminates in a first end portion 15a, and the second leg 17 terminates in a second end portion 17a. The first end portion 15a and the second end portion 17a can be in the shape of a sharpened tip.

Materials useful for the fastener 10 include carbon steel and the like. The crown portion 20 of the fastener 10 can be generally arched and is adapted to receive a generally cylindrical article such as tubing or wiring. The tubing can have a cross-section of various shapes, for example circular, oval, or that of a regular or irregular polygon. The crown portion 20 generally straddles the tubing and is connected on either side to a first shoulder 14 and a second shoulder 16 that respectively abut the mounting surface on opposite sides of the tubing. The U-shaped crown portion 20 can be provided in various shapes and sizes for use with various tubing sizes. The generally U-shaped wire member 11 can have a diameter that ranges from about 0.02 inch to about 0.25 inch. Preferably, the diameter of the generally U-shaped wire member 11 is 0.1 inch.

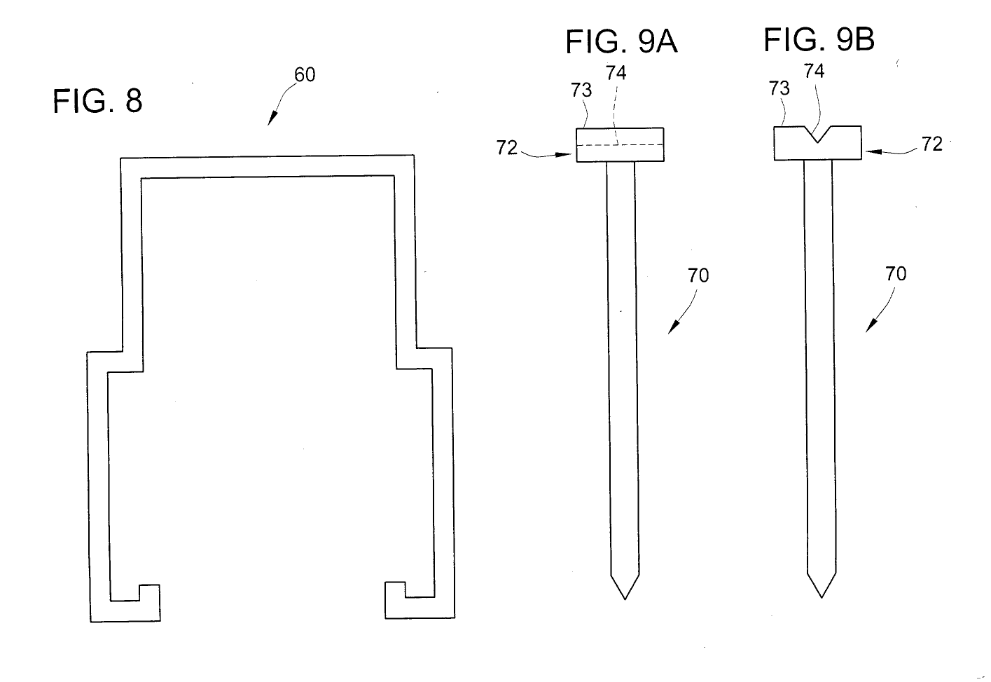

FIG. 4 is a perspective view of the slotted fastener 10 of FIG. 1 in a stack, that is, a plurality of fasteners 10. The stack of fasteners 10 can be loaded into a delivery tool, as described in further detail below. The stack of fasteners 10 can be loaded into a magazine 60 as shown in FIG. 8, as described in further detail below.

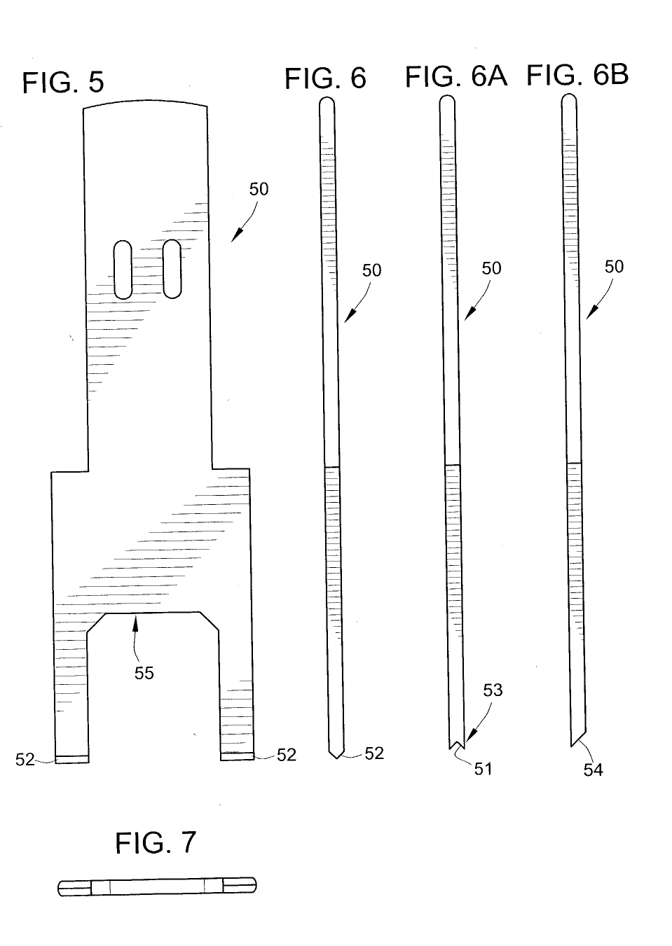

In a preferred embodiment of the present invention, FIGS. 5-7 disclose a ram 50 having a generally convex blade end 52 adapted to generally mate with generally concave slots 30, 32 of a fastener 10, the ram 50 used to attach the fastener 10 to a mounting surface (not shown). The generally convex blade end 52 can be V-shaped. The angle of the V-shaped generally convex blade end can range from about 40° to about 140°. The fastener 10 includes a generally U-shaped wire member 11 having a crown portion 20, a first leg 15, and a second leg 17. The first leg 15 is connected to the crown portion 20 by a first shoulder 14 fashioned to be generally parallel to the mounting surface to which the fastener is to be attached, and the second leg 17 is connected to the crown portion 20 by a second shoulder 16 fashioned to be generally parallel to the mounting surface to which the fastener is to be attached. The first shoulder 14 can have a first generally concave slot 30 and the second shoulder 16 can have a second generally concave slot 32. Both the first generally concave slot 30 and the second generally concave slot 32 generally are distal to the mounting surface. The generally convex blade end 52 of the ram 50 has a convex shape that can mate with the first generally concave slot 30 and the second generally concave slot 32, so that impact forces can be efficiently delivered to the fastener 10. Additionally, the ram 50 of the present invention can effectively drive the fastener 10 in a direction generally perpendicular to a mounting surface. Even if ram 50 is not driven perpendicular to the mounting surface, that is at an angle, generally concave slots 30, 32 can capture the force of the blade such that the fastener 10 will be effectively driven into the mounting surface. That is, even when the force of the ram 50 is delivered at an angle, the force will still be effectively transmitted to the fastener 10 through the generally concave slots 30, 32.

In another embodiment of the present invention, the ram 50 can have a convex blade end 54 that is beveled, as shown in FIG. 6B.

In another embodiment of the present invention is disclosed a fastener 10, with reference to FIG. 1C, for attachment to a mounting surface. The fastener 10 includes a generally U-shaped wire member 11 having a crown portion 20, a first leg 15, and a second leg 17. The first leg 15 is connected to the crown portion 20 by a first shoulder 14 fashioned to be generally parallel to the mounting surface to which the fastener is to be attached, and the second leg 17 is connected to the crown portion 20 by a second shoulder 16 fashioned to be generally parallel to the mounting surface to which the fastener is to be attached. The crown portion 20 can have a generally concave slot 21 generally distal to the mounting surface. For example, the generally concave slot 21 of the crown portion 20 can extend along the entire length or along a portion of the length of the crown portion 20. The generally concave slot 21 of the crown portion 20 can have various geometric shapes, including V-shaped, U-shaped, or other geometric shapes such as rectangular or trapezoidal having one open side, as shown in FIG. 11B. The ram 50 can be fashioned to mate with the generally concave slot 21 of the crown portion 20, so that impact forces can be efficiently delivered to the fastener 10. For example, the ram 50 of FIG. 5 can include a generally arched portion 55 having a convex shape that can mate with the generally concave slot 21 of the crown portion 20. Impact forces can be efficiently delivered to a first shoulder 14 and a second shoulder 16 of the fastener 10. Additionally, the ram 50 of the present invention can effectively drive the fastener 10 in a direction generally perpendicular to a mounting surface.

In another embodiment of the present invention is disclosed a fastener 10, with reference to FIG. 1D, for attachment to a mounting surface. The fastener 10 includes a generally U-shaped wire member 11 having a crown portion 20, a first leg 15, and a second leg 17. The first leg 15 is connected to the crown portion 20 by a first shoulder 14 fashioned to be generally parallel to the mounting surface to which the fastener is to be attached, and the second leg 17 is connected to the crown portion 20 by a second shoulder 16 fashioned to be generally parallel to the mounting surface to which the fastener is to be attached. The first leg 15 can have a first generally concave slot 19 and the second leg 17 can have a second generally concave slot 18. The first generally concave slot 19 faces away from the second leg 17, as shown in FIG. 1D; and the second generally concave slot 18 faces away from the first leg 15, as shown in FIG. 1D. For example, the generally concave slot 19 of the first leg 15 can extend along a portion of the length of the first leg 15 and the generally concave slot 18 of the second leg 17 can extend along a portion of the length of the second leg 17. The generally concave slots 18, 19 can have various geometric shapes, including V-shaped, U-shaped, or other geometric shapes such as rectangular or trapezoidal having one open side, as shown in FIG. 1B. The generally convex blade end 52 of the ram 50 has a convex shape that can mate with the generally concave slot 19 of the first leg 15 and the generally concave slot 18 of the second leg 17. Impact forces can be efficiently delivered to a first shoulder 14 and a second shoulder 16 of the fastener 10. Additionally, the ram 50 of the present invention can effectively drive the fastener 10 in a direction generally perpendicular to a mounting surface.

In addition, another embodiment of the present invention provides a fastener 10 having a combination of multiple generally concave slots 18, 19, 21, 30 and 32 as described above.

In another embodiment of the present invention, a ram 50 having a blade end 53 such as in FIG. 6A can have a generally concave slot 52 in the blade end 53 of the ram 50, while a fastener 10 such as in FIG. 2A can have at least one generally convex ridge 31 on a first shoulder 14 that extends along at least one portion of the first shoulder 14, such that the generally convex ridge 31 of the first shoulder 14 of the fastener 10 can mate with the corresponding generally concave slot 52 in the blade end 53 of the ram 50. The first generally convex ridge 31 can extend along the entire length or along a portion of the length of the first shoulder 14. Thus, impact forces can be efficiently delivered to the fastener 10. Additionally, the ram 50 of the present invention can effectively drive the fastener 10 in a direction generally perpendicular to a mounting surface. Other embodiments and combinations can have similar reversed mating geometries.

In yet another embodiment of the present invention, a ram 50 as in FIG. 5 can include a generally arched portion 55 having a concave shape that can mate with a crown portion 20 of the fastener 10. The crown portion 20 can be a generally cylindrical wire, or include a generally convex ridge similar to the generally convex ridge 31 of the first shoulder 14 of the fastener 10 as shown in FIG. 2A. Impact forces can be efficiently delivered to a first shoulder 14 and a second shoulder 16 of the fastener 10.

For example, the ram 50 of FIG. 5 can include a generally arched portion 55 having a convex shape that can mate with the generally concave slot 21 of the crown portion 20. Impact forces can be efficiently delivered to a first shoulder 14 and a second shoulder 16 of the fastener 10.

In a preferred embodiment the present invention, a fastener 10 is disclosed for attachment to a mounting surface, as shown in FIG. 1. The fastener 10 includes a generally U-shaped wire member 11 having a crown portion 20, a first leg 15, and a second leg 17. The first leg 15 is connected to the crown portion 20 by a first shoulder 14 fashioned to be generally parallel to the mounting surface to which the fastener is to be attached, and the second leg 17 is connected to the crown portion 20 by a second shoulder 16 fashioned to be generally parallel to the mounting surface to which the fastener is to be attached. In this embodiment, the first shoulder 14 is generally perpendicularly connected to the crown portion 20 with respect to the first leg 15 as in FIG. 1, and the second shoulder 16 is generally perpendicularly connected to the crown portion 20 with respect to the second leg 17 as in FIG. 1. The first shoulder 14 can have a first generally concave slot 30 and the second shoulder 16 can have a second generally concave slot 32. Both the first generally concave slot 30 and the second generally concave slot 32 generally are distal to the mounting surface. For example, the first generally concave slot 30 can extend along the first shoulder 14, and the second generally concave slot 32 can extend along the second shoulder 16. In this embodiment, the first generally concave slot 30 and the second generally concave slot 32 are both V-shaped. As shown in FIG. 2, the V-shaped slot 30 can have a depth up to about half the diameter of the generally U-shaped wire member 11. Additionally, the V-shaped slot 30 can have an angle, for example about 90°. The first leg 15 terminates in a first end portion 15a. The first end portion 15a can be in the shape of a sharpened tip. The crown portion 20 of the fastener 10 is generally arched and is adapted to receive a tubing cross-section. The crown portion 20 generally straddles the tubing and has generally parallel sides that respectively abut the mounting surface on opposite sides of the tubing. The U-shaped crown portion 20 can be provided in various shapes and sizes for use with various tubing sizes.

A delivery tool useful in using the embodiments of the present invention is provided to dispense and drive fasteners. The delivery tool can include a base member, a driving member mounted to the base member, the driving member pivotably attached to the base member and movable in an arcuate path relative to the base member, an impact delivery mechanism mounted to the driving member, the impact delivery mechanism including a force delivery member which is movable in a reciprocating manner relative to the driving member, and a ram slidably mounted to the base member, the ram adapted to move generally along a guided direction perpendicular to the mounting surface, the ram positioned to receive at least one impact force from the force delivery member. The delivery tool can hold at least one fastener 10, and preferably a plurality of fasteners 10, within the base member. The delivery tool can include a magazine 60 as shown in FIG. 8 that can hold fastener 10 in a stack. In an embodiment, the magazine 60 or stack of fasteners 10 can be loaded into a channel interiorly of the base member. The magazine 60 is shaped to hold a plurality of fasteners 10.

In another embodiment, shown in FIGS. 9A and 9B, a fastener of the present invention can be a nail 70 having a head 72 including a top surface 73, the head 72 having a generally concave slot 74 extending along the top surface 73. The generally concave slot 74 can extend along the entire length or along a portion of the length of top surface 73 of the head 72.

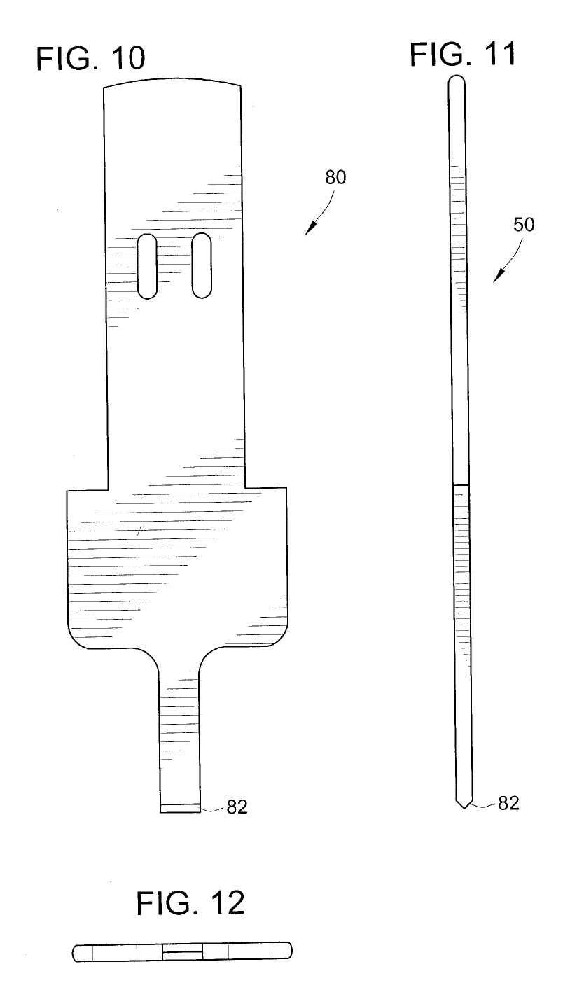

In another embodiment of the present invention, FIGS. 10-12 disclose an alternative ram 80 having a generally convex blade end 82 adapted to mate with a generally concave slot 74 of a nail 70 as in FIG. 9A. The generally convex blade end 82 of the alternative ram 80 has a convex shape that can mate with the generally concave slot 74 of the nail 70, so that impact forces can be efficiently delivered to the nail 70. Additionally, the alternative ram 80 of the present invention can effectively drive the nail 70 in a direction generally perpendicular to a mounting surface.

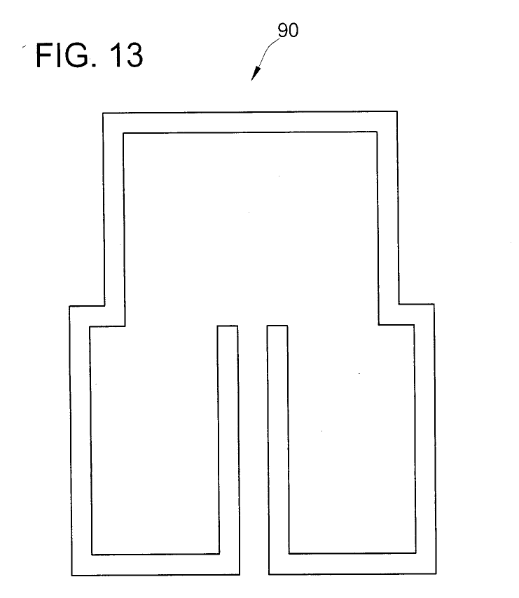

A delivery tool useful in using the embodiments of the present invention is configured to dispense and drive fasteners. The delivery tool can include a base member, a driving member mounted to the base member, the driving member pivotably attached to the base member and movable in an arcuate path relative to the base member, an impact delivery mechanism mounted to the driving member, the impact delivery mechanism including a force delivery member which is movable in a reciprocating manner relative to the driving member, and a ram slidably mounted to the base member, the ram adapted to move generally along a guided direction perpendicular to the mounting surface, the ram positioned to receive at least one impact force from the force delivery member. The delivery tool can hold at least one nail 70 having a generally concave slot 74 as in FIG. 9A, and preferably a plurality of nails 70, within the base member. The delivery tool can include an alternative magazine 90 as shown in FIG. 13 that can hold the nail 70 in a stack. In an embodiment, the magazine 90 or stack of nails 70 can be loaded into a channel interiorly of the base member. The magazine 90 is shaped to hold a plurality of nails 70.

Advantageously, the delivery tool useful in using the embodiments of the present invention reliably drives a fastener 10 to a predetermined depth and no further. According to an aspect of the invention, the delivery tool is effective to deliver the fastener 10 by transmitting numerous quick power-assisted impacts to the nails, yet the delivery tool will not overdrive the fastener 10 beyond a predetermined depth. The delivery tool drives the fastener 10 to the predetermined depth, then stops. According to a preferred embodiment, the impact delivery mechanism of the delivery tool delivers repeated impacts only until the fastener 10 penetrates the mounting surface by a predetermined depth, at which point the impact mechanism automatically ceases.

Another advantage of the present invention is that it provides a delivery tool useful in using the embodiments of the present invention which drives a fastener 10 in a reliably perpendicular orientation relative to a mounting surface. To drive the fastener 10, the delivery tool includes a ram 50, as illustrated in FIGS. 5-7. The ram 50 is slidably disposed near the front end of the base member to move generally along a direction generally perpendicular to a planar mounting surface (not shown). The perpendicularly guided orientation of the ram 50 is desired so that the ram 50, in turn, drives the fastener 10 perpendicularly against the mounting surface (not shown).

The present invention also provides a method for fastening a fastener to a mounting surface by means of a delivery tool having a base member, a driving member mounted to the base member, the driving member pivotably attached to the base member and movable in an arcuate path relative to the base member, an impact delivery mechanism mounted to the driving member, the impact delivery mechanism including a force delivery member which is movable in a reciprocating manner relative to the driving member, and a ram slidably mounted to the base member, the ram adapted to move generally along a guided direction perpendicular to the mounting surface, the ram positioned to receive at least one impact force from the force delivery member, the method comprising: aligning the fastener within the delivery tool; delivering impact forces to the ram toward the fastener in a direction generally perpendicular to the mounting surface; and pushing the fastener with the ram such that at least a portion of the fastener penetrates the mounting surface. The ram can be adapted to generally mate with the fastener. In this embodiment, the impact delivery mechanism can be adapted to cease when a portion of the fastener has penetrated the mounting surface by a predetermined depth.

In an embodiment of the fastening method of the present invention, the fastener is a slotted fastener.

In an embodiment of the fastening method of the present invention, the fastener is a fastener 10 as in FIG. 1. The fastener 10 includes a generally U-shaped wire member 11 having a crown portion 20, a first leg 15, and a second leg 17. The first leg 15 is connected to the crown portion 20 by a first shoulder 14 fashioned to be generally parallel to the mounting surface to which the fastener is to be attached, and the second leg 17 is connected to the crown portion 20 by a second shoulder 16 fashioned to be generally parallel to the mounting surface to which the fastener is to be attached. The fastener 10 is shaped so that at least one concave slot is positioned at and extends along at least one portion of the generally U-shaped wire member 11 in a direction generally distal to the mounting surface. For example, in this embodiment, the first shoulder 14 has a first generally concave slot 30 and the second shoulder 16 has a second generally concave slot 32. Both the first generally concave slot 30 and the second generally concave slot 32 generally are distal to the mounting surface. For example, the first generally concave slot 30 can extend along the first shoulder 14, and the second generally concave slot 32 can extend along the second shoulder 16. The first generally concave slot 30 can extend along the entire length or along a portion of the length of the first shoulder 14, and the second generally concave slot 32 can extend along the entire length or along a portion of the length of the second shoulder 16. The first generally concave slot 30 and the second generally concave slot 32 can have any shape adapted to receive and mate with a ram 50, as discussed above. A ram 50 having a generally convex blade end 52 can be adapted to generally mate with the generally concave slots 30, 32 of the fastener 10, the ram 50 used to attach the fastener 10 to a mounting surface. In this embodiment, the impact delivery mechanism can be adapted to cease when a portion of the fastener 10 has penetrated the mounting surface by a predetermined depth.

In a preferred embodiment of the fastening method of the present invention, the fastener 10 can have a first shoulder 14 that is generally perpendicular to the first leg 15, and a second shoulder 16 that is generally perpendicular to the second leg 17.

The fasteners of the present invention can have multiple concave slots according to the principles of the invention. Alternatively, the fasteners of the present invention can have multiple convex ridges. In one alternative embodiment, the fastener can have a combination of concave slots and convex ridges.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A generally U-shaped wire fastener for attachment to a mounting surface, comprising
a crown portion,
a first leg and a second leg,
the first leg connected to the crown portion by a first shoulder that is generally parallel to the mounting surface, and
the second leg connected to the crown portion by a second shoulder that is generally parallel to the mounting surface;
the first shoulder having a first generally concave slot generally distal to the mounting surface, and
the second shoulder having a second generally concave slot generally distal to the mounting surface.

2. The fastener of claim 1 wherein the first generally concave slot and the second generally concave slot are V-shaped.

3. The fastener of claim 1 wherein the generally U-shaped wire fastener has a diameter of about 0.1 inch.

4. The fastener of claim 1 wherein the crown portion is shaped to receive and hold a generally cylindrical article.

5. The fastener of claim 4 wherein the generally cylindrical article is a length of tubing.

6. The fastener of claim 4 wherein the generally cylindrical article is a length of wiring.

7. The fastener of claim 1 wherein the first generally concave slot and the second generally concave slot are shaped to generally mate with a ram, the ram used to attach the fastener to the mounting surface.

8. The fastener of claim 1 wherein the first shoulder is generally perpendicular to the first leg, and the second shoulder is generally perpendicular to the second leg.

9. The fastener of claim 8 wherein the crown portion is generally arched.

10. The fastener of claim 1 wherein the crown portion is generally arched.

11. A generally U-shaped wire fastener for attachment to a mounting surface, comprising
a crown portion,
a first leg and a second leg,
the crown portion having a generally concave slot generally distal to the mounting surface.

12. The fastener of claim 11 wherein the generally concave slot is V-shaped.

13. The fastener of claim 11 wherein the generally U-shaped wire fastener has a diameter of about 0.1 inch.

14. The fastener of claim 11 wherein the crown portion is shaped to receive and hold a generally cylindrical article.

15. The fastener of claim 14 wherein the generally cylindrical article is a length of tubing.

16. The fastener of claim 14 wherein the generally cylindrical article is a length of wiring.

17. The fastener of claim 1 wherein the generally concave slot is shaped to generally mate with a ram, the ram used to attach the fastener to the mounting surface.

18. The fastener of claim 11 wherein the first leg is connected to the crown portion by a first shoulder that is generally parallel to the mounting surface, and the second leg is connected to the crown portion by a second shoulder that is generally parallel to the mounting surface.

19. The fastener of claim 18 wherein the first shoulder is generally perpendicular to the first leg, and the second shoulder is generally perpendicular to the second leg.

20. The fastener of claim 19 wherein the crown portion is generally arched.

21. The fastener of claim 11 wherein the crown portion is generally arched.

22. A generally U-shaped wire fastener for attachment to a mounting surface, comprising
a crown portion,
a first leg and a second leg,
the first leg connected to the crown portion by a first shoulder that is generally parallel to the mounting surface, and
the second leg connected to the crown portion by a second shoulder that is generally parallel to the mounting surface;
the first leg having a first generally concave slot facing away from the second leg, and
the second leg having a second generally concave slot facing away from the first leg.

23. The fastener of claim 22 wherein the first generally concave slot and the second generally concave slot are V-shaped.

24. The fastener of claim 22 wherein the generally U-shaped wire fastener has a diameter of about 0.1 inch.

25. The fastener of claim 22 wherein the crown portion is shaped to receive and hold a generally cylindrical article.

26. The fastener of claim 25 wherein the generally cylindrical article is a length of tubing.

27. The fastener of claim 25 wherein the generally cylindrical article is a length of wiring.

28. The fastener of claim 22 wherein the first generally concave slot and the second generally concave slot are shaped to generally mate with a ram, the ram used to attach the fastener to the mounting surface.

29. The fastener of claim 22 wherein the first shoulder is generally perpendicular to the first leg, and the second shoulder is generally perpendicular to the second leg.

30. The fastener of claim 29 wherein the crown portion is generally arched.

31. The fastener of claim 22 wherein the crown portion is generally arched.

32. A method for fastening a slotted fastener to a mounting surface by means of a delivery tool having a base member, a driving member mounted to the base member, the driving member pivotably attached to the base member and movable in an arcuate path relative to the base member, an impact delivery mechanism mounted to the driving member, the impact delivery mechanism including a force delivery member which is movable in a reciprocating manner relative to the driving member, and a ram slidably mounted to the base member, the ram adapted to move generally along a guided direction perpendicular to the mounting surface, the ram positioned to receive at least one impact force from the force delivery member, the method comprising:
aligning the slotted fastener within the delivery tool;
delivering impact forces to the ram toward the slotted fastener in a direction generally perpendicular to the mounting surface; and
pushing the slotted fastener with the ram such that at least a portion of the slotted fastener penetrates the mounting surface.

33. The method of claim 32 wherein the ram is shaped to generally mate with the slotted fastener.

34. The method of claim 33 wherein the impact delivery mechanism ceases when a portion of the slotted fastener has penetrated the mounting surface by a predetermined depth.

35. A method for fastening a generally U-shaped wire fastener to a mounting surface by means of a delivery tool having a base member, a driving member mounted to the base member, the driving member pivotably attached to the base member and movable in an arcuate path relative to the base member, an impact delivery mechanism mounted to the driving member, the impact delivery mechanism including a force delivery member which is movable in a reciprocating manner relative to the driving member, and a ram slidably mounted to the base member, the ram adapted to move generally along a guided direction perpendicular to the mounting surface, the ram positioned to receive at least one impact force from the force delivery member, the method comprising:
aligning the fastener within the delivery tool;
delivering impact forces to the ram toward the fastener in a direction generally perpendicular to the mounting surface; and
pushing the fastener with the rain such that at least a portion of the fastener penetrates the mounting surface.

36. The method of claim 35 wherein the generally U-shaped wire fastener comprises
a crown portion,
a first leg and a second leg,
the first leg connected to the crown portion by a first shoulder that is generally parallel to the mounting surface, and
the second leg connected to the crown portion by a second shoulder that is generally parallel to the mounting surface;
the first shoulder having a first generally concave slot generally distal to the mounting surface, and
the second shoulder having a second generally concave slot generally distal to the mounting surface.

37. The method of claim 36 wherein the first generally concave slot and the second generally concave slot are shaped to generally mate with the ram.

38. The method of claim 37 wherein the impact delivery mechanism ceases when a portion of the fastener has penetrated the mounting surface by a predetermined depth.

39. The method of claim 36 wherein the crown portion is shaped to receive and hold a generally cylindrical article.

40. The fastener of claim 36 wherein the first shoulder is generally perpendicular to the first leg, and the second shoulder is generally perpendicular to the second leg.

41. The fastener of claim 40 wherein the crown portion is generally arched.

42. The fastener of claim 36 wherein the crown portion is generally arched.

43. A generally U-shaped wire fastener for attachment to a mounting surface, comprising
a crown portion,
a first leg and a second leg,
the first leg connected to the crown portion by a first shoulder that is generally parallel to the mounting surface, and
the second leg connected to the crown portion by a second shoulder that is generally parallel to the mounting surface;
the first shoulder having a first generally convex ridge generally distal to the mounting surface, and
the second shoulder having a second generally convex ridge generally distal to the mounting surface.

44. The fastener of claim 43 wherein the crown portion is shaped to receive and hold a generally cylindrical article.

45. The fastener of claim 44 wherein the generally cylindrical article is a length of tubing.

46. The fastener of claim 44 wherein the generally cylindrical article is a length of wiring.

47. The fastener of claim 43 wherein the first generally convex ridge and the second generally convex ridge are shaped to generally mate with a ram, the ram used to attach the fastener to the mounting surface.

48. The fastener of claim 43 wherein the first shoulder is generally perpendicular to the first leg, and the second shoulder is generally perpendicular to the second leg.

49. The fastener of claim 48 wherein the crown portion is generally arched.

50. The fastener of claim 43 wherein the crown portion is generally arched.

51. A generally U-shaped wire fastener for attachment to a mounting surface, comprising
a crown portion,
a first leg and a second leg,
the crown portion having a generally convex ridge generally distal to the mounting surface.

52. The fastener of claim 51 wherein the crown portion is shaped to receive and hold a generally cylindrical article.

53. The fastener of claim 52 wherein the generally cylindrical article is a length of tubing.

54. The fastener of claim 52 wherein the generally cylindrical article is a length of wiring.

55. The fastener of claim 51 wherein the generally convex ridge is shaped to generally mate with a ram, the ram used to attach the fastener to the mounting surface.

56. The fastener of claim 51 wherein the first leg is connected to the crown portion by a first shoulder that is generally parallel to the mounting surface, and the second leg is connected to the crown portion by a second shoulder that is generally parallel to the mounting surface.

57. The fastener of claim 56 wherein the first shoulder is generally perpendicular to the first leg, and the second shoulder is generally perpendicular to the second leg.

58. The fastener of claim 57 wherein the crown portion is generally arched.

59. The fastener of claim 51 wherein the crown portion is generally arched.

60. A generally U-shaped wire fastener for attachment to a mounting surface, comprising
a crown portion,
a first leg and a second leg, the first leg connected to the crown portion by a first shoulder that is generally parallel to the mounting surface, and
the second leg connected to the crown portion by a second shoulder that is generally parallel to the mounting surface;
the fastener having at least three generally concave slots generally distal to the mounting surface.

61. A generally U-shaped wire fastener for attachment to a mounting surface, comprising
a crown portion,
a first leg and a second leg,
the first leg connected to the crown portion by a first shoulder that is generally parallel to the mounting surface, and
the second leg connected to the crown portion by a second shoulder that is generally parallel to the mounting surface;
the fastener having at least three generally convex ridges generally distal to the mounting surface.
